(19) United States
(12) Patent Application Publication
(10) Pub. No.: US 2012/0327228 A1
(43) Pub. Date: Dec. 27, 2012

(54) MONITORING SYSTEM, MONITORING APPARATUS, AND MONITORING METHOD

(75) Inventor: Kazuo NOMURA, Fujisawa-shi (JP)

(73) Assignee: JVC KENWOOD CORPORATION, Yokohama-shi (JP)

(21) Appl. No.: 13/530,520

(22) Filed: Jun. 22, 2012

(30) Foreign Application Priority Data
Jun. 24, 2011 (JP) 2011-140565

(51) Int. Cl. H04N 7/18

(52) U.S. Cl. 348/143; 348/E07.085

(57) ABSTRACT

When a plurality of sub-station monitoring apparatuses are controlled by a main station monitoring apparatus, if the sub-station monitoring apparatus detects a change of a plurality of events, the sub-station monitoring apparatus transmits information relating to the event such as the kind of change, the time of event occurrence, or the like to the main station monitoring apparatus instead of transmitting image data. The main station monitoring apparatus determines abnormality/normality of the occurred event, and requests the corresponding sub-station monitoring apparatus to transmit still image data or moving picture data when there is a possibility of abnormality, so as to monitor the event in detail.

### CROSS-REFERENCE TO RELATED PATENT APPLICATIONS

This application claims the benefit of Japanese Patent Application No. 2011-140565, filed on Jun. 24, 2011, in the Japan Patent Office, the disclosure of which is incorporated herein in its entirety by reference.

### BACKGROUND OF THE INVENTION

1. Field of the Invention

The present invention relates to a monitoring system, a monitoring apparatus, and a monitoring method, and more particularly to, for example, a monitoring unit capable of monitoring abnormal states of a plurality of monitoring points without delay even with a communication unit having a low transmission rate such as narrowband wireless communication.

2. Description of the Related Art

Conventionally, a monitoring apparatus for security is installed in empty houses, offices or factories for night surveillance, automated parking garages, and the like. It is most useful to monitor a screen of a surveillance camera to exactly capture an occurrence of an accident such as trespassing by an intruder, fire outbreak, and the like.

For example, as a system for monitoring an automated parking garage, when a plurality of sub-station monitoring apparatuses respectively monitor monitoring sections through a narrowband wireless communication unit (simplex operation system), a falling type system that calls sub-stations sequentially to request transmission of image signals is generally used because it is impossible for one main station monitoring apparatus to wirelessly communicate with a plurality of sub-station monitoring apparatuses at the same time.

In the falling type system as described above, when the number of sub-station monitoring apparatuses increases, a period of circulating all the sub-stations increases, thereby greatly reducing monitoring efficiency.

Therefore, various methods have been suggested as a unit for improving monitoring efficiency as much as possible.

For example, Patent Document 1 discloses an image transmission system, in which image data obtained from captured images of a house is transmitted to a portable information terminal such as a personal digital assistant (PDA) and the like carried by a user who is out of house. The image transmission system does not require any wires because communication between a plurality of cameras and a personal computer (PC) is performed wirelessly. In addition, when the image transmission system catches trespassing by an intruder by detecting a change in captured images of each camera, images of all cameras are synchronized and transmitted to the PDA of the user. In this example, since images of the plurality of cameras are synchronized and transmitted, a monitoring efficiency may be improved.

In addition, Patent Document 2 discloses a still image transmission system using a remote control camera, wherein still images are recorded with information about necessary conditions such as time and weather conditions, and image data suitable for the condition information is read-out if necessary.

However, according to the conventional art, it is difficult to control a plurality of sub-station monitoring apparatuses without delay, when a communication unit having a low transmission rate such as narrowband wireless communication unit is used.

The invention disclosed in Patent Document 1 is efficient in that the image data is transmitted to the user only when a change in the captured images is detected and there is no need to constantly, transmit the image data.

However, if the images are transmitted whenever the change is detected, images that do not need to be transmitted are also transmitted, and thus, a frequency of transmitting data increases. Therefore, when the narrowband wireless communication unit is used, the number of sub-station monitoring apparatuses that may perform monitoring for a predetermined time period is greatly reduced even when an image data compression unit is used.

In the monitoring system disclosed in Patent Document 2, since the still images are recorded with information about necessary conditions such as time or weather conditions and image data that satisfies the conditions is only transmitted, a data amount may be reduced and the number of monitoring stations may be increased. However, since the image satisfying the condition information is determined among the images stored in past, the monitoring cannot be performed in real-time.
(Patent Document 1) Japanese Laid-open Patent Publication No. 2002-232877
(Patent Document 2) Japanese Laid-open Patent Publication No. hei 5-236469

### SUMMARY OF THE INVENTION

The present invention provides a monitoring system, a monitoring method, and a monitoring apparatus capable of efficiently collecting monitoring information from a plurality of sub-station monitoring apparatuses even when a communication system having a low transmission rate is used. Also, the present invention is not limited to a narrowband communication system, and when the present invention is applied to a high transmission rate system, more sub-station monitoring apparatuses can be controlled.

According to an aspect of the present invention, there is provided a monitoring system including: a sub-station monitoring apparatus which includes a plurality of detecting units, and transmits a predetermined event as first data when one or more detecting units detect the predetermined event; and a main station monitoring apparatus which receives and analyzes the first data, and transmits transmission request information to the sub-station monitoring apparatus when second data that is detailed data relating to the predetermined event is needed as an analysis result.

According to another aspect of the present invention, there is provided a main station monitoring apparatus for remotely controlling a sub-station monitoring apparatus in a monitoring system, the main station monitoring apparatus including: a main station receiving unit which receives first data that is about a predetermined event detected by the sub-station monitoring apparatus within a monitoring section, and second data that is status information constantly detected and stored by the sub-station monitoring apparatus and designated as a result of analyzing the first data; an event analyzing unit which analyzes whether the first data satisfies a predetermined condition; a main station controlling unit which generates transmission request information for requesting the sub-station monitoring apparatus to transmit the second data, when the event analyzing unit determines that the first data satisfies the predetermined condition; and a main station transmitting unit which transmits the transmission request information.

According to another aspect of the present invention, there is provided a main station monitoring apparatus for remotely controlling a sub-station monitoring apparatus in a monitoring system, the main station monitoring apparatus including: a main station receiving unit which receives first data that is about a predetermined event detected by the sub-station monitoring apparatus within a monitoring section, and second data that is extracted from data storing status information designated as a result of analyzing the first data from the status information detected and stored by the sub-station monitoring apparatus; an event analyzing unit which analyzes whether the first data satisfies a predetermined condition; a main station controlling unit which generates transmission request information for requesting the sub-station monitoring apparatus to transmit the second data, when the event analyzing unit determines that the first data satisfies the predetermined condition; and a main station transmitting unit which transmits the transmission request information.

According to another aspect of the present invention, there is provided a sub-station monitoring apparatus that is remotely controlled by a main station monitoring apparatus in a monitoring system, the sub-station monitoring apparatus including: a communication unit which communicates with the main station monitoring apparatus; an event detecting unit which detects a predetermined event in a monitoring section of the sub-station monitoring apparatus; a status information acquiring unit which acquires status in the monitoring section as status information; a storage unit which stores the status information; and a sub-station controlling unit which transmits the predetermined event to the main station monitoring apparatus as first data when the event detecting unit detects the predetermined event and at the same time stores status information at the time of detecting the predetermined event in the storage unit, wherein the main station monitoring apparatus transmits transmission request information for requesting the sub-station monitoring apparatus to transmit the designated status information when it is considered that the first data satisfies a predetermined condition as an analyzing result of the main station monitoring apparatus, and the sub-station controlling unit generates second data by extracting the status information designated by the transmission request information from the storage unit and transmits the second data via the communication unit, when the sub-station monitoring apparatus receives the transmission request information.

According to another aspect of the present invention, there is provided a monitoring method for remotely controlling a sub-station monitoring apparatus that monitors a predetermined monitoring section by a main station monitoring apparatus, the monitoring method including: detecting a predetermined event in the monitoring section by the sub-station monitoring apparatus; acquiring and storing status information about detailed status at the time of detecting the event by the sub-station monitoring apparatus; transmitting the predetermined event as first data to the main station monitoring apparatus by the sub-station monitoring apparatus when the predetermined event is detected; receiving and analyzing the first data by the main station monitoring apparatus; transmitting transmission request information for requesting transmission of designated status information to the sub-station monitoring apparatus by the main station monitoring apparatus, when a predetermined condition is satisfied as an analysis result; receiving the transmission request information by the sub-station monitoring apparatus, and extracting the status information as second data designated by the transmission request information from the stored status information; and transmitting the second data to the main station monitoring apparatus by the sub-station monitoring apparatus.

In addition, when it is required to arrange a plurality of sub-station monitoring apparatuses, the sub-station monitoring apparatuses are preferably formed as small as possible. Thus, a capacity of a storage unit (storage unit such as an image memory) for storing status information of the sub-station monitoring apparatus can be one to store data for a time period that is longer than a time period until a transmission request of the second data is transmitted from the main station monitoring apparatus, for example, tens of seconds to a few minutes. Thus, the transmission request information from the main station monitoring apparatus can be awaited while over-writing an old data storage region with new data like a flight recorder of an airplane.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of a parking garage monitoring system according to an embodiment of the present invention;

FIG. 2 is a flowchart describing an example of controlling the parking garage monitoring system of FIG. 1;

FIG. 3 is a view showing an example of communication traffic in the parking garage monitoring system of FIG. 1;

FIG. 4 is a flowchart describing another example of controlling the parking garage monitoring system of FIG. 1; and

FIG. 5 is a block diagram of a monitoring system according to an embodiment of the present invention.

### DETAILED DESCRIPTION OF THE INVENTION

Hereinafter, embodiments of the present invention will be described in detail with reference to accompanying drawings.

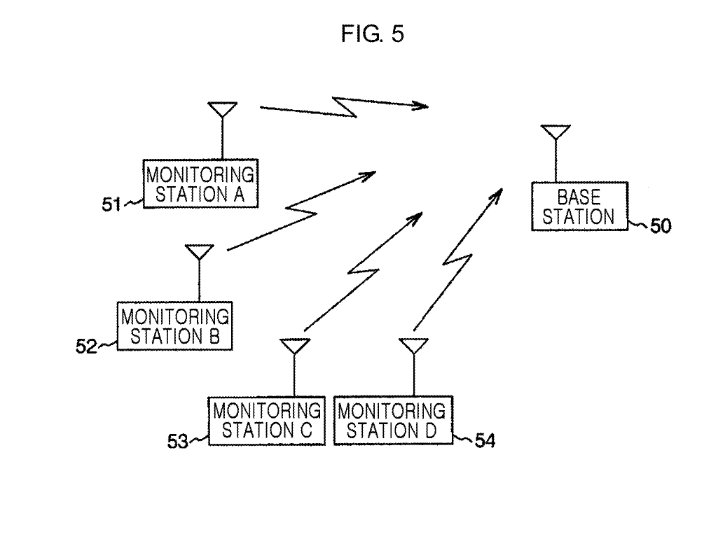

First, a case where the present invention is applied to a monitoring system consisting of one base station (main station monitoring apparatus) and a plurality of monitoring stations A through D (sub-station monitoring apparatuses), as shown in FIG. 5, will be described.

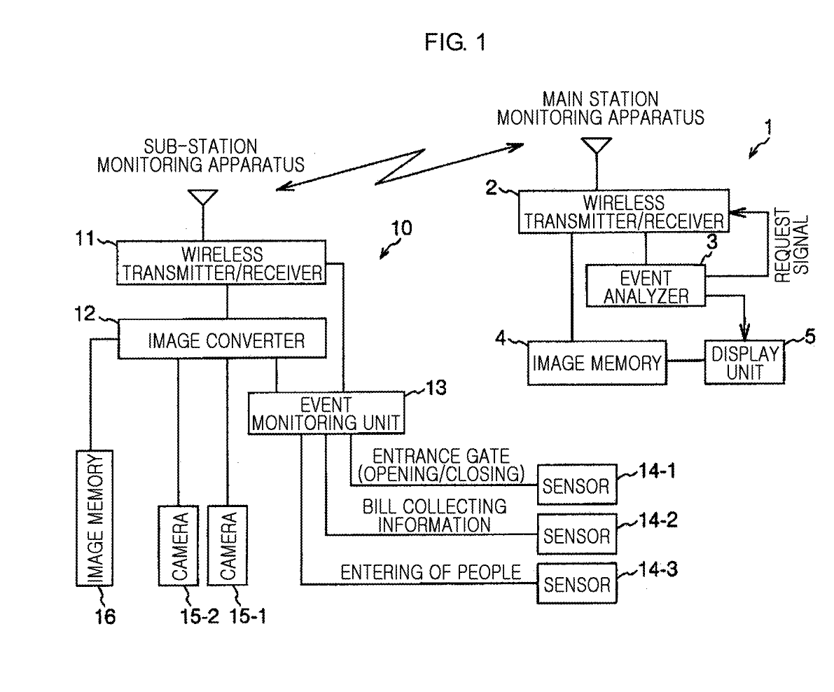

FIG. 1 is a system block diagram showing an embodiment in which the present invention is applied to a parking garage monitoring system.

In FIG. 1, a main station monitoring apparatus 1 and a sub-station monitoring apparatus 10 corresponding to one of the monitoring stations A through D shown in FIG. 5 are shown. Although there are a plurality of sub-station monitoring apparatuses 10, only one sub-station monitoring apparatus is shown and the others are omitted in FIG. 1.

The main station monitoring apparatus 1 includes a wireless transmitter/receiver (main station transmitting unit and a main station receiving unit) 2 communicating with the sub-station monitoring apparatus 10, an event analyzer (event analyzing unit) 3 determining whether an occurrence of an event is abnormal or normal, and requesting transmission of status information to the sub-station monitoring apparatus 10 when it is determined that the occurrence of the event is abnormal, an image memory 4 recording image signals transmitted from the sub-station monitoring apparatus 10, a display unit 5 such as a liquid crystal display (LCD), and a main station control unit (not shown).

The sub-station monitoring apparatus 10 includes a wireless transmitter/receiver (sub-station transmitting unit and a sub-station receiving unit) 11 communicating with the main station monitoring apparatus 1, an image converter 12 compressing image data from a camera or generating still image data from moving picture data, an event monitoring unit 13 detecting whether an event occurs by collecting signals from one or more sensors, sensors for detecting occurrence of an event (event detecting unit which may include the event monitoring unit 13) 14-1 through 14-3, image capturing cameras (status information acquiring units) 15-1 and 15-2 acquiring detailed information relating to a change of the event, and an image memory (storage unit) 16. In addition, although not shown in FIG. 1, the event monitoring unit 13 is provided with a function for generating time information or a sub-station controlling function (sub-station controlling unit) for controlling the whole sub-station monitoring apparatus 10.

In the above configuration, the sensors 14-1 through 14-3 in the sub-station monitoring apparatus 10 may include, for example, a sensor 14-1 for sensing opening/closing of a gate of a car entrance, a bill collecting information sensor 14-2 of a parking rate calculator to which a parking fee is input, and a sensor 14-3 for sensing entering/exiting of people. The sensing results of the sensors 14-1 through 14-3 are respectively supplied to the event monitoring unit 13. The event monitoring unit 13 monitors an event of opening/closing the gate of the car entrance, an event of inputting a fee in the parking rate calculator, and an event of entering/exiting of people by signals from the sensors (14-1 through 14-3). In addition, when it is determined that an event has occurred, the event monitoring unit 13 adds occurrence time information to an image signal (still image or moving picture) of a monitoring camera and stores the image signal in the image memory 16, and at the same time, transmits the event occurrence time and sensor information (including a kind of a sensor) as event data (first data) to the main station monitoring apparatus 1 via the wireless transmitter/receiver 11. If the image signal includes a still image, one image frame to a few image frames per second may be recorded in the image memory 16 so that a rough shape may be recognized.

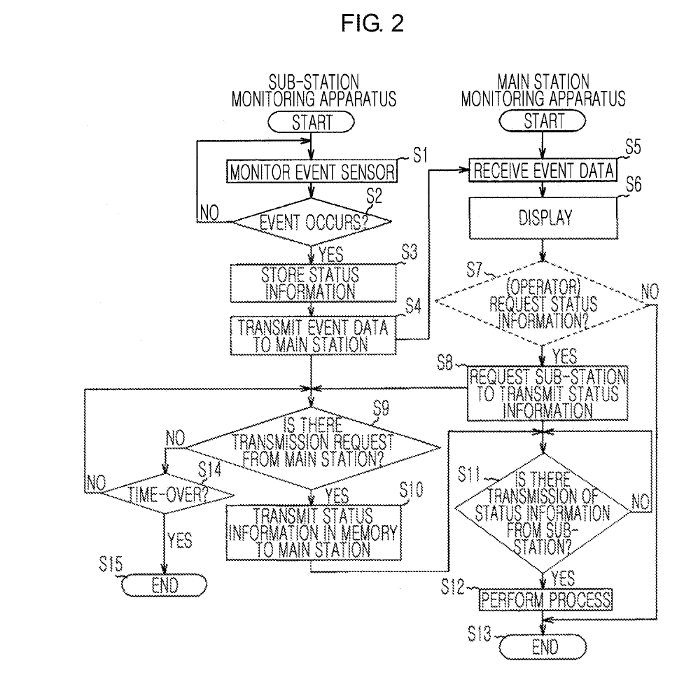

FIG. 2 is a flowchart describing an example of controlling the parking garage monitoring system of FIG. 1, wherein a left part shows controlling of the sub-station monitoring apparatus 10 and a right part shows controlling of the main station monitoring apparatus 1, and both parts are shown how they are related.

When processes of the sub-station monitoring apparatus 10 start, sensing results of the sensor 14-1 for sensing the opening/closing of the gate of the car entrance, the bill collecting information sensor 14-2 of the parking rate calculator in which the parking fee is input, and the sensor 14-3 sensing the entering/exiting of people are supplied to the event monitoring unit 13 as described above (S1). The event monitoring unit 13 senses signals from the sensors 14-1 through 14-3 (S2). When it is determined that an event occurred (YES at S2), the event monitoring unit 13 stores an image signal (still image or moving picture) of the monitoring camera in the image memory 16 (S3), and at the same time, transmits the event occurrence time and sensor information as event data(first data) to the main station monitoring apparatus 1 via the wireless transmitter/receiver 11 (S4).

In addition, the transmission of the event data may be performed independently by each of the sensors 14-1 through 14-3, or all the event data that occurred within a predetermined time period may be transmitted at once.

When the main station monitoring apparatus 1 receives the event data from the sub-station monitoring apparatus 10 (S5), the event analyzer 3 analyzes time-serial changes of the sensors 14-1 through 14-3, and an analysis result is displayed on the display unit 5 (S6). In the present embodiment, a case where an operator (a human) determines whether the event is abnormal or normal from the display is shown as an example (S7).

The determination of abnormal/normal states is performed as follows. For example, when the transmitted event data represents a case where the gate is left open (a case where a signal detecting the closing of the gate is not transmitted even when a predetermined time has passed since a signal detecting the opening of the gate is transmitted from a sensor of the gate) or a case where a car passes without paying the parking fee (a case where a signal detecting the opening of the gate is transmitted from the gate sensor but a signal detecting the input of the parking fee is not transmitted from the bill collecting information sensor), the operator (a human) regards the event as abnormal.

As described above, when the operator determines that the event is abnormal from the display (YES at S7), the operator manipulates a controller (not shown) to request the sub-station monitoring apparatus 10 to transmit status information (image data), and then, the main station monitoring apparatus 1 transmits a status information transmission request signal (transmission request information) to the sub-station monitoring apparatus 10 via the wireless transmitter/receiver 2 (S8).

The sub-station monitoring apparatus 10 waits for the status information (image signal) transmission request signal (transmission request information) from the main station monitoring apparatus 1 (S9). When the status information (image signal) transmission request signal is received (YES at S9), the image data (still image or moving picture: second data) stored in the image memory 16 is transmitted to the main station monitoring apparatus 1 (S10). In addition, the event data (first data) transmitted from the sub-station monitoring apparatus 10 to the main station monitoring apparatus 1 includes the event occurrence time and the sensor information. Thus, the image data is read out based on such information, and then is transmitted to the main station monitoring apparatus 1. Otherwise, a session management number or the like may be assigned to each piece of image data to manage the image data.

The main station monitoring apparatus 1 receives the image data transmitted from the sub-station monitoring apparatus 10 (YES at S11), processes the image data (S12), and ends the processes (S13). Although detailed descriptions about the processes are omitted here, the processes may include displaying the transmitted image data on the display unit 5, and determining whether there is an abnormal state or whether an additional operation has to be performed according to the state determined by the operator.

In addition, in operation S9 of the sub-station monitoring apparatus 10, in which the sub-station monitoring apparatus 10 waits for the status information transmission request signal from the main station monitoring apparatus 1, a standby time that is set in advance is counted by a timer, and when the preset time has passed (YES at S14), the sub-station monitoring apparatus 10 considers that the main station monitoring apparatus 1 has determined that there is no abnormal state, and the processing flow ends (S15).

According to the monitoring system, although the sub-station monitoring apparatus 10 constantly detects whether an event occurs, the information representing the kind of the sensor detecting the occurrence of an event, that is, in this embodiment, representing which one of the opening/closing of the car entrance gate, the bill collecting information, and the entering/exiting of people has occurred, and the time information of the event occurrence are transmitted to the main station monitoring apparatus 1 as event data only when there is a change in the event detected by the sensors, and thus, the event data transmitted from the sub-station monitoring apparatus 10 does not need to include image data and an amount of data can be reduced.

In addition, the main station monitoring apparatus 1 determines whether an event is abnormal from the time-serial change of the event, and requests the transmission of the image data only when there is a possibility of abnormality. Thus, when there is no possibility of an abnormal event, the event data is only transmitted from the sub-station monitoring apparatus 10, and thus, an amount of data to be transferred is greatly reduced.

In addition, a capacity of a storage unit (storage unit such as the image memory) for storing the status information of the sub-station monitoring apparatus 10 can be one to store data for a time period that is longer than a time period until the transmission request of the second data is transmitted from the main station monitoring apparatus 1, for example, tens of seconds to a few minutes. Thus, if the transmission request information from the main station monitoring apparatus 1 is awaited while over-writing an old data storage region with new data, a capacity of the memory can be reduced.

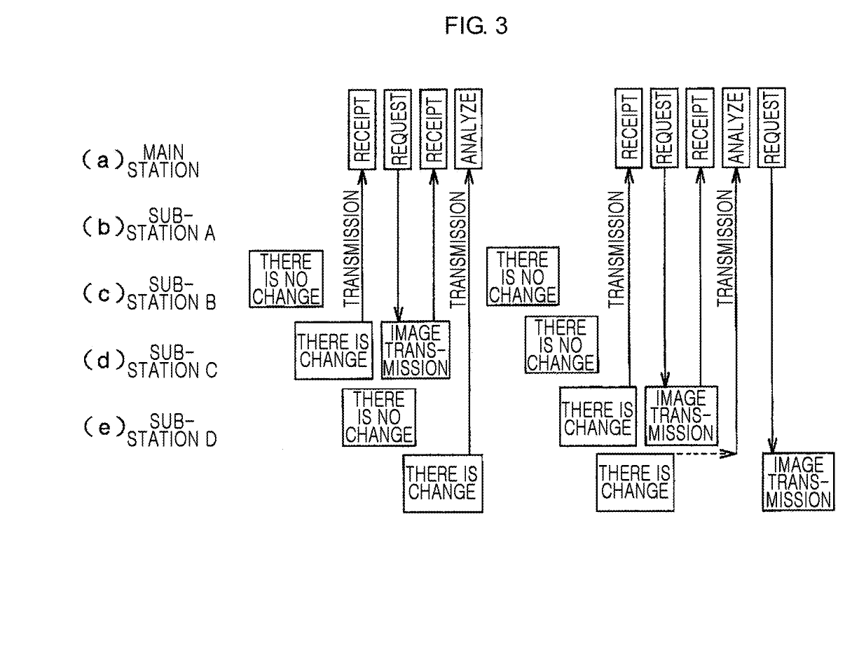

FIG. 3 is a view showing an example of occurrence of traffics when the main station monitoring apparatus 1 remotely controls four sub-station monitoring apparatuses A through D according to the embodiment of the present invention. As clearly shown in FIG. 3, when there is no event change detected by the sub-station monitoring apparatus 10, there is no need to transmit/receive data and the main station monitoring apparatus 1 waits for the transmission of the event data from the sub-station monitoring apparatus 10, and thus, the possibility of generating complex traffic is greatly reduced.

Also, in the embodiment shown in FIG. 3, timings of transmitting the event data from the sub-station monitoring apparatuses A through D to the main station monitoring apparatus 1 are set (scheduled) in advance according to a falling type; however, the event data can be transmitted asynchronously when the transmission of event data is necessary. In this case, a unit for transmitting a receipt response signal representing that the event data has been received without colliding with the transmission from other sub-station monitoring apparatuses from the main station monitoring apparatus 1 to the sub-station monitoring apparatus 10 is desirably included. In addition, if there is no response signal within a predetermined time period, the transmission of the event data may be performed again or predetermined times until the response signal is received from the main station monitoring apparatus

In the above embodiment, the operator determines an abnormal/normal event based on the event data in the main station monitoring apparatus 1; however, the determination can be performed automatically by programming software that performs the above processes. In this case, determination that transmission of the image data at what time and which location regarding the detected event data is requested to the sub-station monitoring apparatus 10 may be performed according to various combinations of the detected event data.

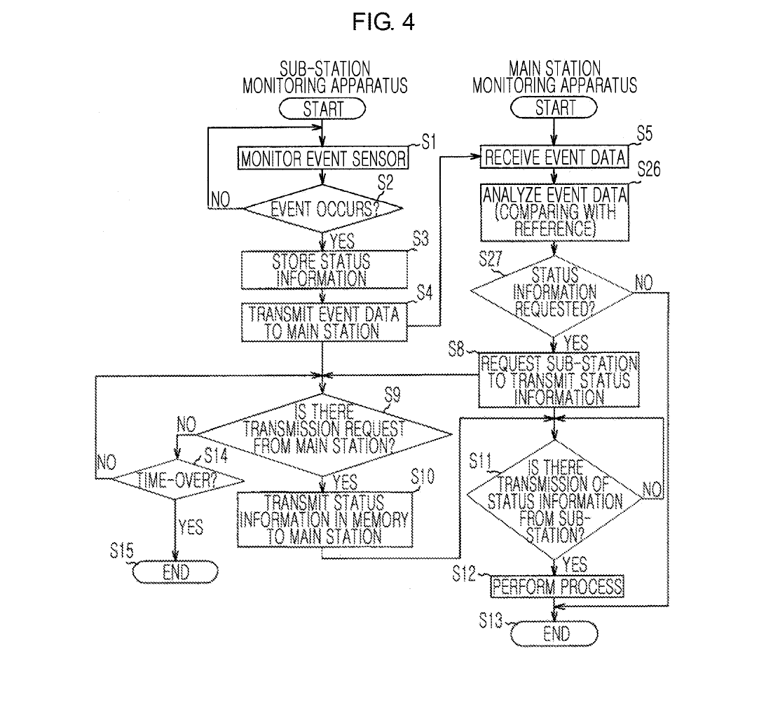

FIG. 4 is a flowchart showing a modified example of the present invention. The flowchart of FIG. 4 is different from the flowchart of FIG. 2 in that operations S6 and S7 are respectively changed as operations S26 and S27, and the other operations are the same as each other. That is, in FIG. 4, when the main station monitoring apparatus 1 receives the event data from the sub-station monitoring apparatus 10 (S5), the event analyzer 3 analyzes time-serial changes in the plurality of event sensors (14-1 through 14-3) to determine whether the event is abnormal or normal (S26 and S27).

In the processes, programmed software is installed so as to achieve the goal. Here, according to the kinds of various event detecting sensors included in the sub-station monitoring apparatus 10, various abnormal states, for example, time-serial order of occurrences of events, a missing part in the event occurrence, occurrence of an additional event, and the like, are resumed in advance as many as possible. In addition, a data table in which a time-serial order of the event occurrences corresponding to the such abnormal states is recorded as a reference event is prepared, and can be compared with the event data transmitted from the sub-station monitoring apparatus 10 to determine whether the event is an abnormal/normal. In a case where it has to be determined whether the event occurs or not from sensor outputs, such as a temperature, a smoke concentration or a gas concentration, and a time interval, a threshold value is set in advance, and a normal state can be determined when the detected value is within a requirement range.

For example, in a case where the gate is left open (a signal representing the closed state of the gate is not received even after a predetermined time has passed since a signal representing that the opening of the gate is detected by the sensor of the gate is transmitted), it is not efficient that the operator (a human) monitors the time period from the opening of the gate to the closing of the gate every time. Thus, the opening/closing time of the gate is calculated by using software, and when the calculated time is equal to or greater than a predetermined threshold value, there is a possibility that the abnormal event occurs. Therefore, in this case, the main station monitoring apparatus 1 is configured to request transmission of the status information to the sub-station monitoring apparatus 10, and then, the determination of the abnormality or the generation and transmission of the transmission request information can be automatically performed.

The above description is about a case where the present invention is applied to a monitoring system of a parking garage; however, the present invention is not limited thereto and can be applied to various monitoring systems.

For example, in the above embodiment, sub-station monitoring apparatuses monitor monitoring objects of the same type, for example, a plurality of parking garages located at various locations. However, the present invention is not limited thereto, and sensors including wireless communication units and arranged at a plurality of locations in one facility can be considered as the sub-station monitoring apparatuses to monitor an abnormality/normality in the facility. For example, various sensors including the wireless communication units and image capturing units are arranged at a plurality of locations in a factory plant, an office to be surveilled at night or in holidays, an empty house, and the like, and in the same manner as above, a main station monitoring system in the facility collects event occurrence information from the sensors (sub-station monitoring apparatuses) to monitor an abnormal/normal event, and when the event is determined as abnormal, the main station monitoring apparatus may transmit the event data to a monitoring center or the like that corresponds to a second main station monitoring apparatus.

Also, as a modified example, a function of determining an abnormality/normality simply may be added to the sub-station monitoring apparatuses of the above embodiment, and when the sub-station monitoring apparatuses determine that there is an abnormal event, the sub-station monitoring apparatuses transmit detailed event data to the main station monitoring apparatus. Then, the main station monitoring apparatus determines an abnormality/normality in detail, and after that, the main station monitoring apparatus may request the sub-station monitoring apparatuses to transmit the status information if necessary.

The sensors detecting the event include the sensors detecting the opening/closing of entrance gate, the bill collecting information, and the entering/exiting of people as an example; however, the present invention is not limited thereto, and the sensors may be a temperature sensor, a humidity sensor, and a radioactive sensor detecting quantities and numerical values, or the camera itself may be used as the event detecting unit.

The event data is not necessarily limited to two values, that is, H/L, +/−, and ON/OFF, for example, the temperature sensor that is described above as an example of detecting a quantity or a numerical value monitors the temperature, and may transmit temperature data when the temperature exceeds a certain threshold value. In this case, the main station monitoring apparatus may perform a determination of requesting transmission of detailed status information on the occurred event based on the numerical range of the transmitted temperature data.

In addition, after the event data from the plurality of sub-station monitoring apparatuses is totally determined, the sub-station monitoring apparatus to which the transmission request of the image data will be transmitted may be designated. In addition, if the sub-station monitoring apparatus includes a plurality of cameras, a certain one of the plurality of the cameras may be designated to transmit the image data.

The status information is not limited to image data. The status information may be information including sound data that has a greater data amount than that of the event data and detected by a detecting unit, for example, a microphone (sound), or may be information including image and sound data that are simultaneously detected. Also, the status information may not be the data obtained by a detecting unit that is different from the sensor detecting the event data, but can be data obtained by a unit detecting the event.

Otherwise, the event may be detected by a unit that acquires status information.

For example, the sub-station monitoring apparatus includes a plurality of radioactive sensors that may detect radioactive materials, and a detected value from each of the radioactive sensors is stored in a memory. Then, a certain radioactive material is generally detected as event data, and when the detected value exceeds a threshold value, the main station monitoring apparatus can perform an analysis based on the detected value and can request the radioactive sensor to transmit data about a plurality of radioactive materials (status information) at the time when the event data is detected.

As an example of detecting the event from the unit acquiring the status information, the occurrence of the event may be detected by using a well-known unit, for example, a image recognition from camera images, detection of a certain voice frequency from an output signal of a microphone, or the like.

In addition, in the present invention, both of the event detecting unit and the status acquiring unit may be detecting units and may be distinguished by difference in the amounts of detected information. Thus, the event detecting unit and the status acquiring unit can be set appropriately according to circumstances of use.

According to the present invention, the first data having a less transmission amount is used in the general monitoring operation, and the detailed second data having a greater data amount than that of the first data used in the general monitoring operation is transmitted by requesting the sub-station monitoring apparatuses to transmit the second data when detailed information is necessary. Therefore, the present invention may be applied to various monitoring systems that require the above operations.

Also, when there is a need to arrange a plurality of sub-station monitoring apparatuses, it is desirable that the sub-station monitoring apparatuses are formed as small as possible. Thus, as described above, a capacity of the storage unit such as the image memory in the sub-station monitoring apparatus is set to store data for tens of seconds to a few minutes, and the old data memory region is overwritten with new data. However, when a small memory device with high capacity is developed by a high density technology or a high contraction technology of moving picture data is developed more, a memory having a capacity that can store the moving picture data for a longer period can be used. Thus, when the occurrence of the event is detected, the main station monitoring apparatus can request the sub-station monitoring apparatus to transmit the moving picture data (status information) of a desired time period before and after the occurrence of the event, for example, from three seconds before the event occurrence to five seconds after the event occurrence.

Also, the communication unit between the main station monitoring apparatus and the sub-station monitoring apparatus is not limited to the wireless communication unit, that is, the communication unit can be a wired communication unit. Also, if a broadband (high rate) communication unit is used instead of a narrowband (low rate) communication unit, more sub-station monitoring apparatuses can be controlled.

According to the present invention, when the sub-station monitoring apparatus detects a change in an event, the detailed data at that time, for example, the status information, such as the still image data or the moving picture data, is stored in the memory, and at the same time, information relating to the event (event data) such as the kind of event, the time when the event occurs, and the like, is transmitted to the main station monitoring apparatus instead of transmitting the detailed data relating to the change of the event. Then, in the main station monitoring apparatus, the operator or the determination processing program determines whether the occurrence of the event is abnormal or normal, and when there is a possibility of an abnormality, the operator or the determination processing program can control the main station monitoring apparatus to request the corresponding sub-station monitoring apparatus to transmit the still image data or the moving picture data.

Therefore, the amount of information transmitted from each of the sub-station monitoring apparatuses to the main station monitoring apparatus when the event occurs is greatly reduced, thereby realizing a monitoring system including more sub-station monitoring apparatuses.

While this invention has been particularly shown and described with reference to exemplary embodiments thereof, it will be understood by one or ordinary skill in the art that various changes in form and details may be made therein without departing from the spirit and scope of the invention as defined by the appended claims.

What is claimed is:

1. A monitoring system comprising:
a sub-station monitoring apparatus which includes a plurality of detecting units, and transmits a predetermined event as first data when one or more detecting units detect the predetermined event; and
a main station monitoring apparatus which receives and analyzes the first data, and transmits transmission request information to the sub-station monitoring apparatus when second data that is detailed data relating to the predetermined event is needed as an analysis result.

2. The monitoring system of claim 1, wherein the second data is data of status information designated by the transmission request information, among a plurality of pieces of status information about detailed status relating to the predetermined event detected by a certain detecting unit among the plurality of detecting units.

3. The monitoring system of claim 1, wherein the sub-station monitoring apparatus is a monitoring apparatus which monitors a predetermined monitoring section, and the sub-station monitoring apparatus comprises:
an event detecting unit which detect a predetermined event in the monitoring section;
a status information acquiring unit which acquires the status information in the monitoring section;
a storage unit which stores the status information with a time of detecting the event, when the predetermined event is detected by the event detecting unit;
a sub-station receiving unit which receives the transmission request information from the main station monitoring apparatus;
a sub-station controlling unit which analyzes the transmission request information and extracts the status information designated by the transmission request information from the storage unit to generate the second data; and
a sub-station transmitting unit which transmits the first data when the predetermined event is detected by the event detecting unit and transmits the second data when the transmission request information is received,
wherein the main station monitoring apparatus comprises:
a main station receiving unit which receives the first data or the second data;
an event analyzing unit which analyzes the first data;
a main station controlling unit which designates the status information that is to be requested when the event analyzing unit determines that the event satisfies a predetermined condition and generates the transmission request signal for requesting the sub-station monitoring apparatus to transmit the designated status information; and
a main station transmitting unit which transmits the transmission request information.

4. The monitoring system of claim 3, wherein the predetermined event is detected by a signal from a predetermined sensor included in the sub-station monitoring apparatus.

5. The monitoring system of claim 3, wherein the predetermined condition refers to a case where a combination of the plurality of occurring events, an occurrence order of the plurality of events, a time interval between the occurrences of the plurality of events, or a numerical value of the occurring event satisfies a predetermined condition.

6. The monitoring system of claim 3, wherein the status information acquiring unit acquires moving pictures or still images detected by an image detecting unit.

7. The monitoring system of claim 6, wherein the status information designated by the transmission request information is the still image at a predetermined time or moving pictures within a predetermined time period stored in the storage unit.

8. A main station monitoring apparatus for remotely controlling a sub-station monitoring apparatus in a monitoring system, the main station monitoring apparatus comprising:
a main station communication unit which communicates with the sub-station monitoring apparatus;
an event analyzing unit which analyzes whether first data satisfies a predetermined condition, when the main station communication unit receives the first data that is data of a predetermined event detected by the sub-station monitoring apparatus in a monitoring section; and
a main station controlling unit which generates transmission request information for requesting the sub-station monitoring apparatus to transmit designated status information as second data from the status information about a detailed status stored at the time when the event occurs in the monitoring section by the sub-station monitoring apparatus, when the event analyzing unit determines that the first data satisfies the predetermined condition.

9. The main station monitoring apparatus of claim 8, wherein the predetermined condition refers to a case where a combination of the plurality of occurring events, an occurrence order of the plurality of events, a time interval between the occurrences of the plurality of events, or a numerical value of the occurring event satisfies a predetermined condition.

10. A sub-station monitoring apparatus that is remotely controlled by a main station monitoring apparatus in a monitoring system, the sub-station monitoring apparatus comprising:
a communication unit which communicates with the main station monitoring apparatus;
an event detecting unit which detects a predetermined event in a monitoring section of the sub-station monitoring apparatus;
a status information acquiring unit which acquires detailed status about the predetermined event in the monitoring section as status information;
a storage unit which stores the status information; and
a sub-station controlling unit which transmits the predetermined event to the main station monitoring apparatus as first data via the communication unit when the event detecting unit detects the predetermined event and at the same time stores status information at the time of detecting the predetermined event in the storage unit, wherein the main station monitoring apparatus transmits transmission request information for requesting the sub-station monitoring apparatus to transmit the designated status information when it is considered that the first data satisfies a predetermined condition as an analyzing result of the main station monitoring apparatus, and the sub-station controlling unit generates second data by extracting the status information designated by the transmission request information from the storage unit and transmits the second data via the communication unit, when the sub-station monitoring apparatus receives the transmission request information.

11. The sub-station monitoring apparatus of claim 10, wherein the predetermined event is detected by a signal from a predetermined sensor included in the sub-station monitoring apparatus.

12. A monitoring method for remotely controlling a sub-station monitoring apparatus that monitors a predetermined monitoring section by a main station monitoring apparatus, the monitoring method comprising:
detecting a predetermined event in the monitoring section by the sub-station monitoring apparatus;
acquiring and storing status information about detailed status at the time of detecting the event by the sub-station monitoring apparatus;
transmitting the predetermined event as first data to the main station monitoring apparatus by the sub-station monitoring apparatus when the predetermined event is detected;
receiving and analyzing the first data by the main station monitoring apparatus;
transmitting transmission request information for requesting transmission of designated status information to the sub-station monitoring apparatus by the main station monitoring apparatus, when a predetermined condition is satisfied as an analysis result;
receiving the transmission request information by the sub-station monitoring apparatus, and extracting the status information as second data designated by the transmission request information from the stored status information; and
transmitting the second data to the main station monitoring apparatus by the sub-station monitoring apparatus.
